(19) United States
(12) Patent Application Publication
(10) Pub. No.: US 2015/0125325 A1
(43) Pub. Date: May 7, 2015

(54) SPRING-ENERGIZED SEAL FOR HIGH TEMPERATURE SEALING OF POWER CABLE TO CONNECTOR

(71) Applicant: GE OIL & GAS ESP, INC., OKLAHOMA CITY, OK (US)

(72) Inventors: Edward John Flett, Oklahoma City, OK (US); Ilya Golberg, Oklahoma City, OK (US)

(73) Assignee: GE OIL & GAS ESP, INC., OKLAHOMA CITY, OK (US)

(21) Appl. No.: 14/072,301

(22) Filed: Nov. 5, 2013

(51) Int. Cl. F04D 13/06; F04D 13/10; F04D 13/08; H01R 13/52; H02K 11/00

(52) U.S. Cl. CPC F04D 13/0693; H01R 13/5205; H02K 11/0094; F04D 13/086; F04D 13/10
USPC 417/423.3; 439/271; 310/71

(57) ABSTRACT

A high temperature connector for use in connecting a power cable to an electric motor includes an outer housing, an inner housing inside the outer housing and a cable conductor disposed through the inner housing. To maintain a seal around the cable conductor during thermal expansion and contraction, the connector includes at least one spring-energized seal disposed around the cable conductor. The spring-energized seal permits the expansion and contraction of the cable conductor without deforming the cable conductor or the inner housing.

### FIELD OF THE INVENTION

This invention relates generally to the field of submersible pumping systems, and more particularly, but not by way of limitation, to a connector for use in connecting a power cable to a component in a downhole pumping system.

### BACKGROUND

Submersible pumping systems are often deployed into wells to recover petroleum fluids from subterranean reservoirs. Typically, the submersible pumping system includes a number of components, including one or more fluid filled electric motors coupled to one or more high performance pumps. Each of the components and sub-components in a submersible pumping system must be engineered to withstand an inhospitable downhole environment, which may include wide ranges of temperature, pressure and corrosive well fluids.

Typically a power cable and motor lead cable supply power to downhole components through a pothead connection. High temperature electrical pothead designs often use a compression seal, like an o-ring, to seal the cable insulation to the inner block of the pothead's housing. As the cable insulation expands under high downhole temperatures, such as temperatures approaching or exceeding 250° C., the insulation presses against the compression seal, and the compression seal expands until it is compressed into the mounting grooves of the pothead's housing. This expansion may also cause the compression seal to press into and deform the cable insulation. When the downhole temperature cycles back down, the insulation contracts back down toward the copper core of the cable. If the insulation was deformed by the expansion of the compression seal, the compression seal may not properly seal onto the insulation. Without a proper seal, well fluid may leak through the pothead and into the motor or other downhole component. Well fluid leaking into the motor can cause decreased motor performance and eventual motor failure.

Accordingly, there is the need for an improved sealing device that will allow expansion to occur at high temperatures without deformation of the cable insulation and incorporate the sealing mechanism into a single, simple, compact design. It is to these and other deficiencies in the prior art that the present invention is directed.

### SUMMARY OF THE INVENTION

In preferred embodiments, the present invention includes a high temperature connector for use in connecting a power cable to an electric motor. The connector includes an outer housing, an inner housing inside the outer housing and at least one cable conductor disposed through the inner housing. To maintain a seal around the cable conductor during thermal expansion and contraction, the connector includes at least one spring-energized seal disposed around the cable conductor. The spring-energized seal permits the expansion and contraction of the cable conductor without deforming the cable conductor or the sealing mechanism against the inner housing.

### BRIEF DESCRIPTION OF THE DRAWINGS

FIG. 1 is an elevational view of a submersible pumping system constructed in accordance with a presently preferred embodiment.

FIG. 2 is a perspective view of the connector for connecting the motor lead extension to the motor of the pumping system.

FIG. 3 is a cross sectional view of the connector from FIG. 2.

FIG. 4 is a front view of the spring-energized seal from the connector of FIG. 2.

FIG. 5 is a perspective view of the spring-energized seal from FIG. 4.

### DETAILED DESCRIPTION OF THE PREFERRED EMBODIMENTS

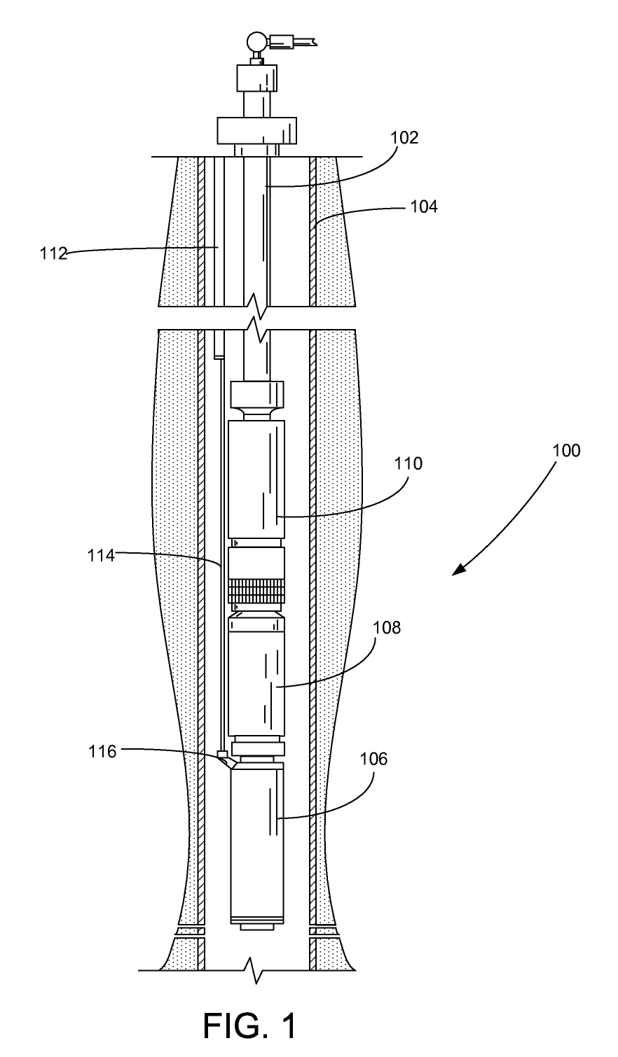

In accordance with a preferred embodiment of the present invention, FIG. 1 shows an elevational view of a pumping system 100. The pumping system 100 is attached to production tubing 102 and is disposed in a wellbore 104. The pumping system 100 includes a variety of downhole components, e.g. an electric motor 106, a seal section 108, a pump 110 and a power cable 112.

The pumping system 100 further includes a motor lead extension (MLE) 114 and pothead connector 116. The MLE 114 is preferably configured to have a lower profile than the power cable 112 because it resides within the smaller annular space between the pumping system 100 and the wellbore 104. The MLE 114 may also include additional armor and shielding to guard against damage from contact with the pumping system 100. The power cable 112 extends downhole and is connected to the MLE 114 on its lower end. The MLE 114, in turn, is connected to the pothead connector 116, which secures the MLE 114 to the motor 106. Alternatively, the power cable 112 may extend from the surface directly to the connector 116.

Although the power cable 112 and MLE 114 are depicted in FIG. 1 as being connected to the motor 106, it will be understood that the power cable 112 or MLE 114 may be connected to other components of the pumping system 100 through the connector 116. It will also be understood that, although each of the components of the pumping system are primarily disclosed in a submersible application, some or all of these components can also be used in surface pumping operations. It will further understood that although the components of the pumping system 100 are depicted in a vertical orientation, it will be appreciated that the pumping system 100 can also be disposed in a horizontal or deviated wellbore 104.

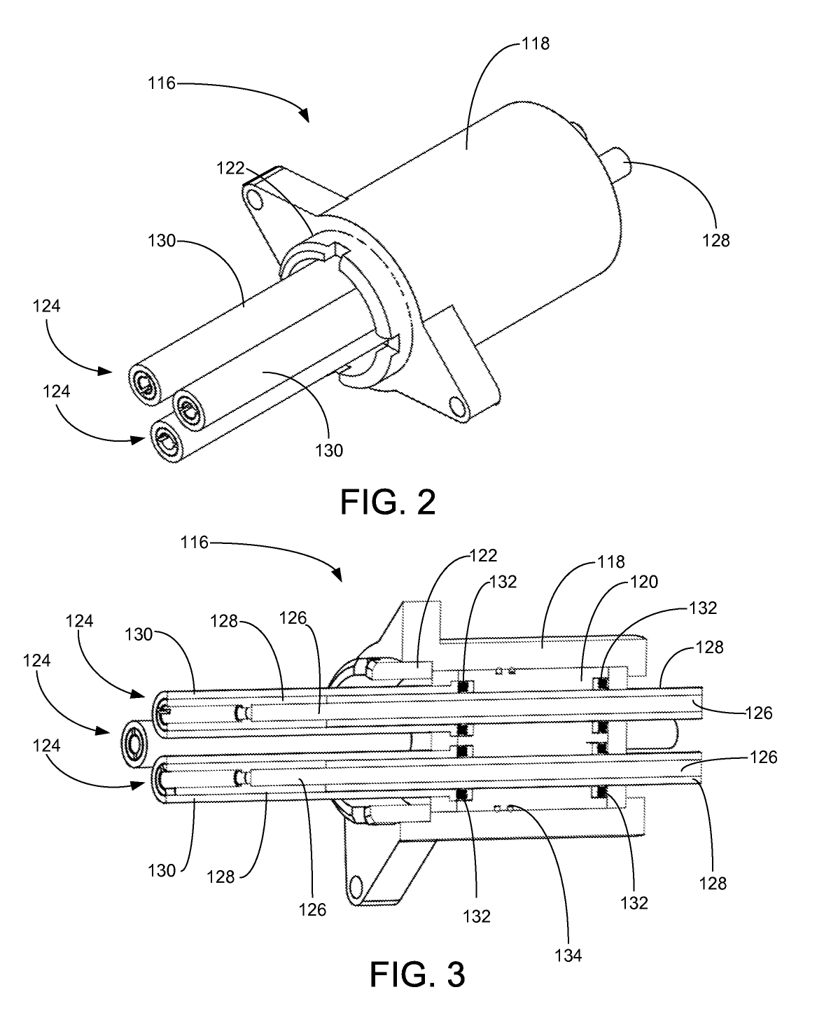

Turning now to FIGS. 2 and 3, depicted therein are perspective and cross sectional views, respectively, of the connector 116. The connector 116 includes an outer housing 118, an inner housing 120, and a compression nut 122. The connector 116 includes flanges that are configured for connection to the motor 106 with bolts or other fasteners (not shown). The outer housing 118 is preferably manufactured from a corrosion-resistant metal, ceramic or heat-resistant plastic. The inner housing 120 is manufactured from a metallic material of suitable thermal expansion property or an electrically insulating, heat-resistant polymer such as polyether ether ketone (PEEK), or ceramic. The compression nut 122 secures the inner housing 120 within the outer housing 118.

The connector 116 further includes one or more cable conductors 124 that pass through the compression nut 122 and inner housing 120 of the connector 116. In a particularly preferred embodiment, the connector 116 includes three cable conductors 124 that each correspond to a different phase of electrical power provided to the three-phase electric motor 106.

Each of the cable conductors 124 includes a core 126, an insulating layer 128 and a sheath 130. The core 126 typically consists of copper or another conductive material to provide an electrical connection to the motor 106 or other component of the pumping system 100. The insulating layer 128 is made out of an insulating material, such as Ethylene Propylene Diene monomer (EPDM), polyether ether ketone (PEEK) or epitaxial co-crystallized perfluoropolymer. The sheath 130 acts as a protective barrier to protect the cable conductors 124 from hazardous, high temperature well environments. Each of the cable conductors 124 is configured for connection with the MLE 114 and internal wiring within the motor 106.

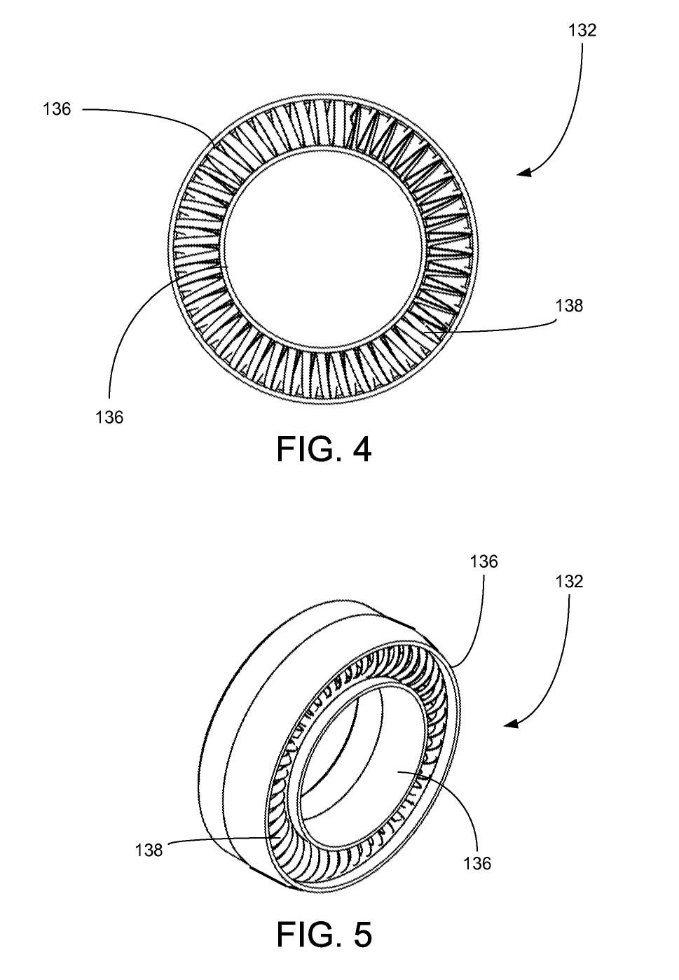

The connector 116 further includes one or more spring-energized seals 132 and may also include one or more o-rings 134. The number of spring—energized seals and o-rings will vary depending on thermal expansion difference between inner housing 120 and outer housing 118. As depicted in FIGS. 4 and 5, the spring-energized seal 132 includes two or more lip seal flaps 136 and a spring 138 running between the two or more lip seal flaps 136. In a preferred embodiment, the spring 138 is a coiled or spiraled metal wire or strip. The resiliency of spring 138 allows the seal 132 to repeatedly expand and contract without permanent deformation.

During the operation of the motor 106, the connector 116 is exposed to cycles of increasing and decreasing temperatures. During these thermal cycles, the insulating layer 128 of the cable conductors 124 undergoes alternating periods of expansion and contraction around the core 126 of the cable conductors 124. As the insulating layer 128 expands, it presses outward on the spring-energized seal 132. The spring-energized seal 132 accommodates the expansion and contraction of the insulating layer 128 of the conductors 124 to maintain a fluid seal through the connector 116.

More particularly, during expansion of the insulating layer 128, the spring 138 in the spring-energized seal 132 is radially compressed, thereby allowing the insulating layer 128 of the cable conductors 124 to expand toward the inner housing 120 of the connector 116 without deformation of the insulating layer 128. As the temperature recedes and the insulating layer 128 contracts, the spring 138 expands and presses the lip seal flaps 136 back onto the insulating layer 128. Thus, the spring-energized seal 132 maintains a seal around the cable conductors 124 which prevents well fluid from passing through the inner housing 120 of the connector 116 and into the motor 106.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A high temperature connector for use in connecting a power cable to an electric motor, the connector comprising:
an outer housing;
an inner housing inside the outer housing;
a cable conductor disposed through the inner housing; and
at least one spring-energized seal disposed around the cable conductor.

2. The connector of claim 1, wherein the at least one spring-energized seal comprises:
two or more lip seal flaps; and
a spring running between the two or more lip seal flaps.

3. The connector of claim 2, wherein the spring comprises a spiraled metal coil.

4. The connector of claim 3, wherein the spring exerts a force in an outward radial direction.

5. The connector of claim 1, wherein each of the cable conductors further comprises:
an outer sheath;
an insulating layer; and
a conductive core.

6. The connector of claim 1, further comprising a compression nut that secures the inner housing within the outer housing.

7. The connector of claim 1, further comprising one or more o-ring seals disposed between the inner housing and outer housing.

8. A downhole pumping system comprising:
an electric motor;
a pump driven by the electric motor;
a power cable; and
a connector connected between the power cable and the electric motor, wherein the connector comprises:
an outer housing;
an inner housing inside the outer housing;
a cable conductor disposed through the inner housing; and
at least one spring-energized seal disposed around the cable conductor.

9. The downhole pumping system of claim 8, wherein the at least one spring-energized seal comprises:
two or more lip seal flaps; and
a spring running between the two or more lip seal flaps.

10. The downhole pumping system of claim 9, wherein the spring comprises a spiraled metal coil.

11. The downhole pumping system of claim 10, wherein the spring exerts a force in an outward radial direction.

12. The downhole pumping system of claim 8, wherein each of the cable conductors further comprises:
an outer sheath;
an insulating layer; and
a conductive core.

13. The downhole pumping system of claim 8, further comprising a compression nut that secures the inner housing within the outer housing.

14. The downhole pumping system of claim 8, further comprising one or more o-ring seals disposed between the inner housing and outer housing.

15. The downhole pumping system of claim 8, further comprises a motor lead extension connected between the power cable and the connector.

16. An electric motor assembly for use in a downhole pumping system, the electric motor assembly comprising:
a fluid filled electric motor;
a motor lead extension that is connected to a power cable; and
a connector connecting the motor lead extension to the fluid filled motor, wherein
the connector comprises:
an outer housing;
an inner housing inside the outer housing;
a cable conductor disposed through the inner housing; and
at least one spring-energized seal disposed around the cable conductor.

17. The electric motor assembly of claim 16, wherein the at least one spring-energized seal comprises:
two or more lip seal flaps; and
a spring running between the two or more lip seal flaps.

18. The electric motor assembly of claim 16, wherein each of the cable conductors further comprises:
an outer sheath;
an insulating layer; and
a conductive core.

19. The downhole pumping system of claim 16, further comprises a motor lead extension connected between the power cable and the connector.
